(19) United States
(12) Patent Application Publication
(10) Pub. No.: US 2003/0047938 A1
(43) Pub. Date: Mar. 13, 2003

(54) Combination greeting card and envelope

(76) Inventor: Eric W. Epstein, New Haven, CT (US)

Correspondence Address: Charles E. Temko, 22 Marion Road, Westport, CT, 06880, US

(21) Appl. No.: 09/949,327

(22) Filed: Sep. 10, 2001

(51) Int. Cl. B42D 15/00

(52) U.S. Cl. 283/116

(57) ABSTRACT

A combination greeting card and envelope in which the envelope is provided with open areas at one or more locations to enable a preview of portions of the card prior to opening the envelope, whereby delivered mail may be more rapidly sorted by a receiver prior to opening.

### BACKGROUND OF THE INVENTION

This invention relates generally to the field of stationery, and more particularly to combination greeting cards and associated envelopes used for invitations and announcements of various occasions. Such cards are well known in the art, and the invention lies in specific constructional details which provides improved recognition.

With the increased flow of so-called “junk” mail, and increased efforts on the part of the sender to design such pieces to resemble legitimate mail, receivers often waste considerable time sorting and opening mail which would normally be routinely discarded without the necessity of opening the envelope or wrapper. Such junk mail is often labeled as “invitation” without further specification or similar designation, when in fact, the piece is merely an advertisement for goods or services. Thus, it would be desirable to provide genuine invitations or greeting cards which can be immediately perceived by a viewer as genuine by being able to view at least particular portions of the contents of a received envelope through a conveniently placed opening therein.

It is known in the art to provide a generally rectangularly-shaped opening substantially centrally in a wall of an envelope so that an underlying address on an insert is visible, this being a common technique used in a return envelope accompanying an invoice. Such envelopes are of limited utility for the purpose contemplated by the present disclosure.

### SUMMARY OF THE INVENTION

Briefly stated, the invention contemplates the provision of a combination greeting card and envelope therefor in which the surface of the card is imprinted at a specific area with a recognizable image typically at an edge or a corner of a rectangular card, although the card need not be of rectangular configuration. The corresponding envelope is provided with a corresponding opening in one planar wall which may be of decorative shape so that when the card is properly inserted, the printed area referred to above will be visible to a viewer without the necessity of first opening the envelope, thus permitting the receiver to sort the card from a group of other discardable mail. The opening in the envelope may be decoratively shaped to correspond to the displayed image on the card.

### BRIEF DESCRIPTION OF THE DRAWINGS

In the drawings, to which reference will be made in the specification, similar reference characters have been employed to designate corresponding parts throughout the several views.

FIG. 1 is a view in elevation of a greeting card embodying a part of the disclosed embodiment.

FIG. 2 is a view in elevation of a corresponding envelope therefor.

FIG. 3 is a view in elevation showing the placement of the card within the envelope such that a portion of the card is viewable through a corresponding opening in a wall of the envelope.

FIG. 4 is a view in elevation of an alternate form of the embodiment.

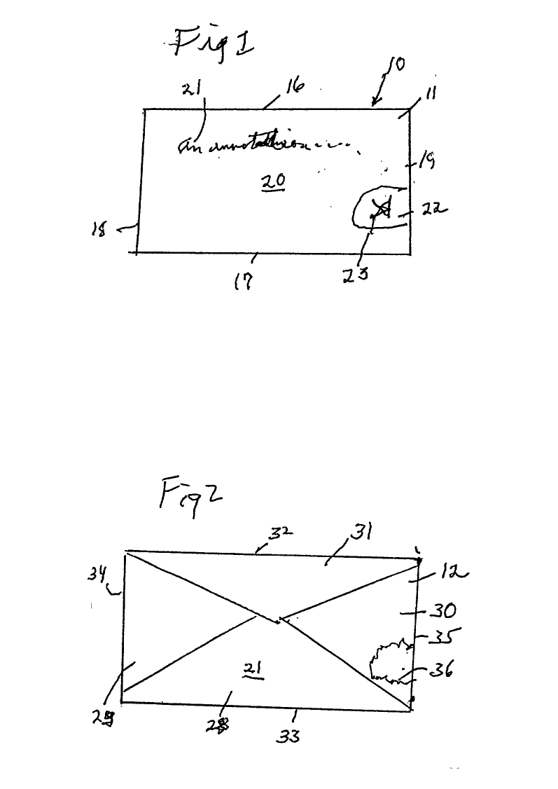

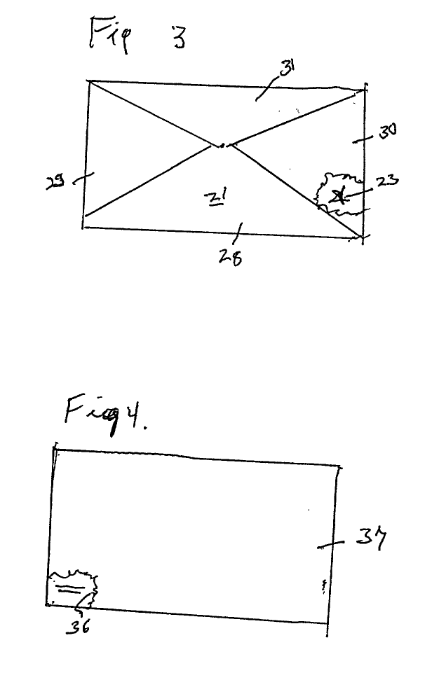

### DETAILED DESCRIPTION OF THE DISCLOSED EMBODIMENTS

In accordance with the first embodiment of the invention, the device, generally indicated by reference character 10, comprises a greeting card element 11 and an envelope element 12.

The card element 11 will normally be of rectangular configuration, although not necessarily so, and is bounded by first and second longer side edges 16 and 17, first and second end edges 18 and 19, and at least one printed surface 20. The surface 20 includes a first area 21 upon which a suitable message may be imprinted, and a second area 22 which carries an ornamental display 23, at least a portion of which is intended to be viewable through at least one corresponding opening in the envelope element 12.

The envelope element 12 is of generally conventional construction, including a first planar wall carrying an address surface (not shown), and a rear surface 21 which may include glued bottom flap 28, side flaps 29 and 30, and an upper flap 31 which is normally sealed by the user after insertion of the card. When sealed, the envelope is bounded by side edges 32 and 33, as well as end edges 34 and 35.

The side flap 30 is provided with a decorative opening of any convenient shape which permits the second area 22 to be viewed therethrough.

FIG. 4 illustrates a modified form of the embodiment in which the opening in the same is placed in the forward or address side of the envelope, and is located at a corner. It is also possible to form the opening by cutting a rectangular area of both the front and back walls of the envelope through which a corner of the corresponding card projects. In such case, the exposed portion of the card should not project beyond the converging edges of the envelope to conform to current postal regulations. It is also possible to provide multiple exposed display areas on the greeting card with corresponding openings situated at different portions of the surface of the envelope, and these corresponding areas may be positioned on both surfaces of the card with corresponding openings in both walls of the envelope.

Other variations are possible within the scope of the invention, and the wall of the envelope containing the opening may be imprinted adjacent the edge of the opening with any additional indicia desired. Where the card is of non-rectangular configuration, it preferably is bounded by at least two rectilinear edges meeting at a right angle to assist in positioning the same within the envelope, which for practical purposes, should be of generally rectangular configuration. Both the card element and the envelope element may be manufactured using conventional technology, it being necessary only to provide one or more additional cutting operations through the plane of the unfolded element at a predetermined location. Where a wide variety of openings and locations are desired, this may be performed as a separate rule die stamping operation.

I wish it to be understood that I do not consider the invention to be limited to the precise details of structure shown and described in the specification, for obvious modifications will occur to those skilled in the art to which the invention pertains.

I claim:

1. In combination greeting card and envelope therefor, into which said card is selectively positioned, the improvement comprising: said card having at least one surface having a first area for displaying a message, and a second relatively smaller area with a distinctive design positioned upon said second area; said envelope having at least one wall having an opening corresponding in location and size to that of said second area when said card is positioned within said envelope.

2. The improvement set forth in claim 1, in which said opening in said envelope is positioned adjacent a rectilinear edge thereof.

3. The improvement set forth in claim 1, in which said opening in said envelope is positioned inwardly of the edges of said envelope.

4. The improvement set forth in claim 1, in which plural second areas are positioned on opposite surfaces of said card element, said envelope having corresponding openings in each of two parallel walls
